(19) United States
(12) Patent Application Publication
(10) Pub. No.: US 2016/0125517 A1
(43) Pub. Date: May 5, 2016

(54) SENSORY-PREFERENCE-PROFILE-BASED SHOPPING SYSTEMS AND METHODS

(71) Applicant: Preference Science Technologies, Inc., Seattle, WA (US)

(72) Inventor: Cynthia HOLCOMB, Seattle, WA (US)

(21) Appl. No.: 14/872,614

(22) Filed: Oct. 1, 2015

Related U.S. Application Data
(60) Provisional application No. 62/058,966, filed on Oct. 2, 2014.

(51) Int. Cl. G06Q 30/06

(52) U.S. Cl. CPC G06Q 30/0641; G06Q 30/0631

(57) ABSTRACT

Systems and methods for sensory-preference-profile-based shopping are provided herein.

### FIELD

The present disclosure relates to the field of electronic commerce, and more particularly, to automatically determining a consumer-preference profile based on consumer selections of meta-tagged images.

### BACKGROUND

Electronic commerce, commonly known as e-commerce, refers to the buying and selling of products and/or services over electronic systems such as the Internet and other computer networks. While purchasing products over the Internet and other electronic systems is widespread and growing, many e-commerce merchants have observed that conversion rates are frequently higher in bricks-and-mortar stores, especially those that employ skilled sales professionals to help shoppers identify products that the shoppers may be interested in purchasing.

For example, many high-end department stores employ sales associates who can observe and interact with a shopper to help the shopper select articles of clothing (or other products). Frequently, the sales associate may develop an intuitive sense of the shopper's style and/or tastes based on observing what the shopper is wearing, observing articles of clothing (or other products) that the shopper shows interest in, and/or observing the shopper's reactions to articles of clothing (or other products) that the sales associate may select and present to the shopper.

Too often, e-commerce merchants do not or cannot offer such skilled sales associates to assist shoppers, instead relying on the shopper to know what he or she wants and where to find it. Existing e-commerce systems may lack techniques for automatically determining aspects of a shopper's tastes and/or style preferences. Moreover, existing e-commerce online shopping systems are cluttered with too many non-relevant products, which may contribute to lower online conversion rates.

Moreover, previously known online shopping experiences, exemplified by prior-art shopping user-interface 100 (shown in prior-art FIG. 1), tend to be specification-driven, requiring the user to specify many dimensions of filtering criteria (e.g., product category, size, color, price, brand, and the like), but still returning an overwhelming number of results. Consequently, online conversion rates have been stuck at approximately 3% since 1995, meaning that 97% of website shoppers do not make a purchase. At least part of the problem is that the e-commerce website typically does not know much or anything about a given consumer's preferences.

### BRIEF DESCRIPTION OF THE DRAWINGS

FIG. 1 illustrates a specification-driven, prior-art shopping user-interface.

FIG. 2 illustrates a preference-based personal curation user-interface, in accordance with one embodiment.

FIG. 3 illustrates a preference-based sensory shopping user-interface, in accordance with one embodiment.

FIG. 4 illustrates a consumer-preference profile system in accordance with one embodiment.

FIG. 5 illustrates several components of an exemplary preference-profile server in accordance with one embodiment.

FIG. 6 illustrates several components of an exemplary preference-profile consumer device in accordance with one embodiment.

FIG. 7 illustrates a routine for determining a consumer-preference profile based on consumer selections of meta-tagged images, such as may be performed by a preference-profile server and/or a preference-profile consumer device in accordance with one embodiment.

FIG. 8 illustrates a subroutine for obtaining an ordered consumer selection list based on a given set of meta-tagged images, such as may be performed by a preference-profile server in accordance with one embodiment.

FIG. 9 illustrates a subroutine for determining a consumer-preference profile based on one or more given ordered consumer-selection lists, such as may be performed by a preference-profile server in accordance with one embodiment.

FIGS. 10A-F illustrate an alternate set of exemplary metadata that may be employed in connection with a set of meta-tagged images, in accordance with one embodiment.

FIG. 11A illustrates exemplary metadata that may be employed in connection with a set of meta-tagged images, in accordance with one embodiment.

FIG. 11B also illustrates exemplary metadata that may be employed in connection with a set of meta-tagged images.

FIG. 11C also illustrates exemplary metadata that may be employed in connection with a set of meta-tagged images.

FIG. 11D also illustrates exemplary metadata that may be employed in connection with a set of meta-tagged images.

FIG. 11E also illustrates exemplary metadata that may be employed in connection with a set of meta-tagged images.

FIG. 11F also illustrates exemplary metadata that may be employed in connection with a set of meta-tagged images.

FIG. 11G also illustrates exemplary metadata that may be employed in connection with a set of meta-tagged images.

FIG. 12 illustrates an exemplary garment having characteristics similar to those described in FIGS. 11A-G, in accordance with one embodiment.

### DESCRIPTION

In various embodiments as described herein, various techniques may be employed to determine a consumer's sensory preferences by presenting to the consumer a series of image-sets, each including a plurality of images that are tagged with metadata associating each image with one or more visual-aesthetic profile categories. Based on which images the consumer does (and does not) select, a consumer-preference profile may be built for the consumer, enabling product recommendations that are aligned with the determined consumer-preference profile. Similar sensory profiles may be built for a set of products. Various embodiments may provide visual input that mimics the contextual experience of the sensory and emotional stimuli a shopper experiences in the “real world” retail shopping environment, translating into a set of sensory preferences that influence the shopper's choices while shopping.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

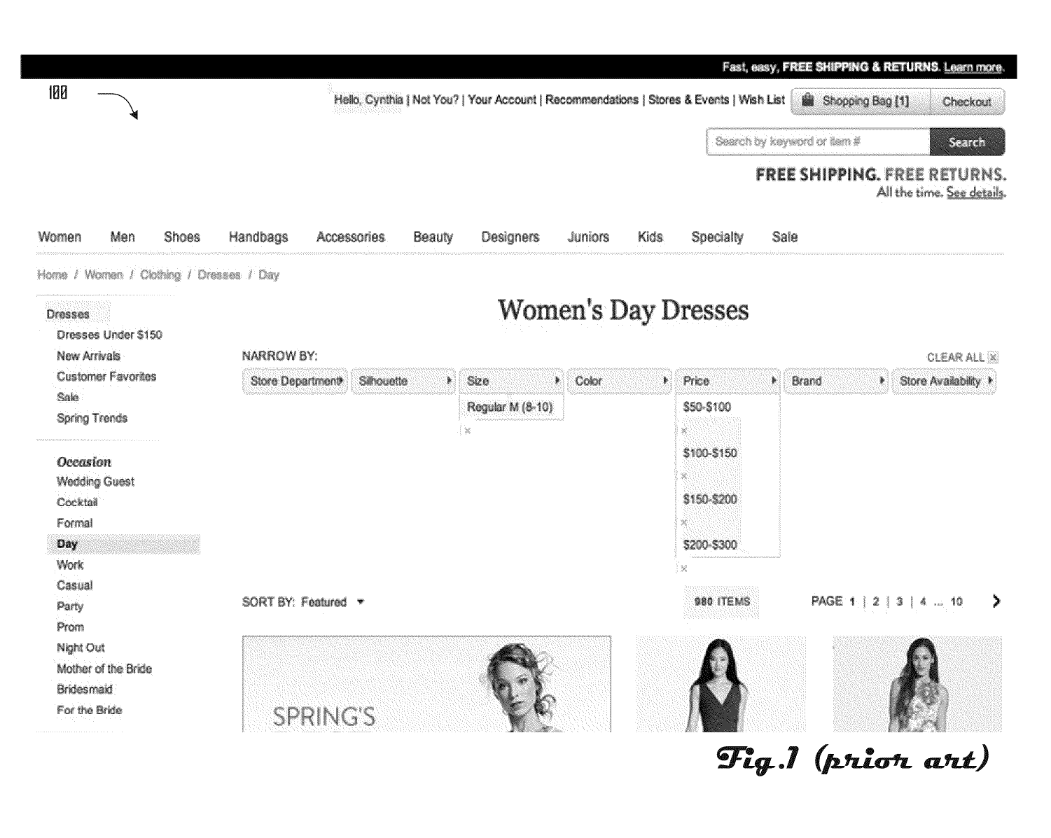

FIG. 1 illustrates a specification-driven, prior-art shopping user interface 100 (discussed above).

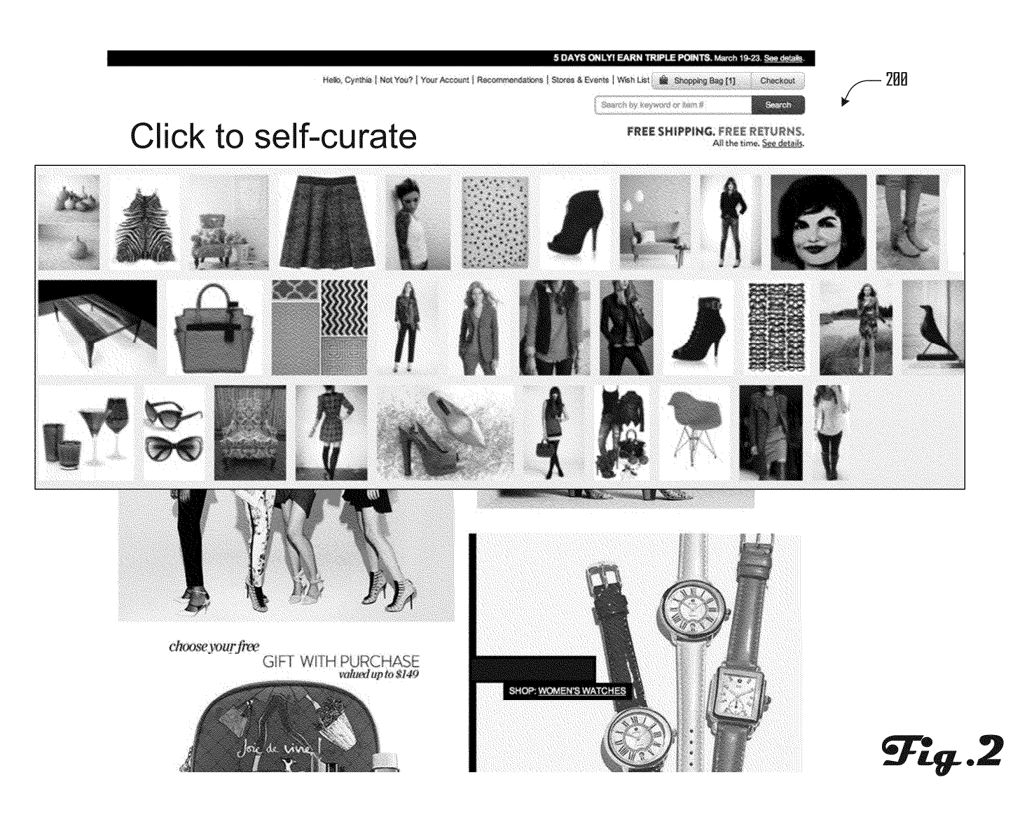

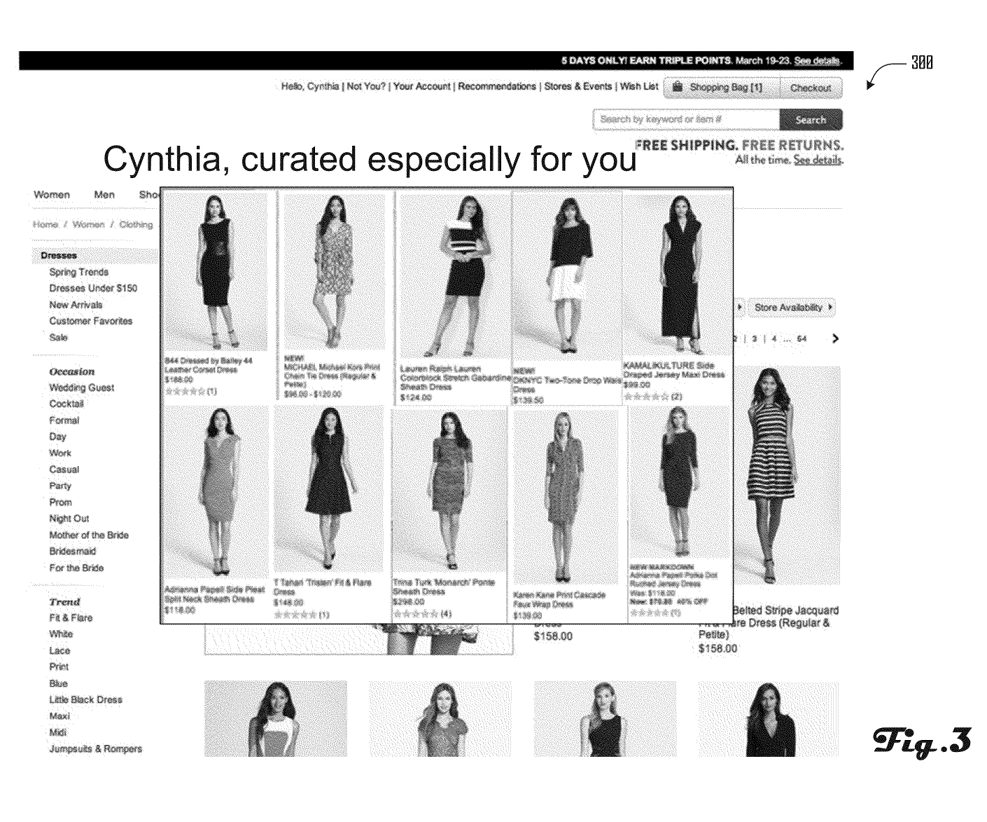

FIG. 2 illustrates a preference-based personal curation user interface 200, in accordance with one embodiment. In contrast to prior-art shopping user-interface 100 (see FIG. 100, discussed above), personal curation user interface 200 provides the shopper with an opportunity to click on or otherwise select meta-tagged images that collectively indicate a sensory-preference profile for the consumer.

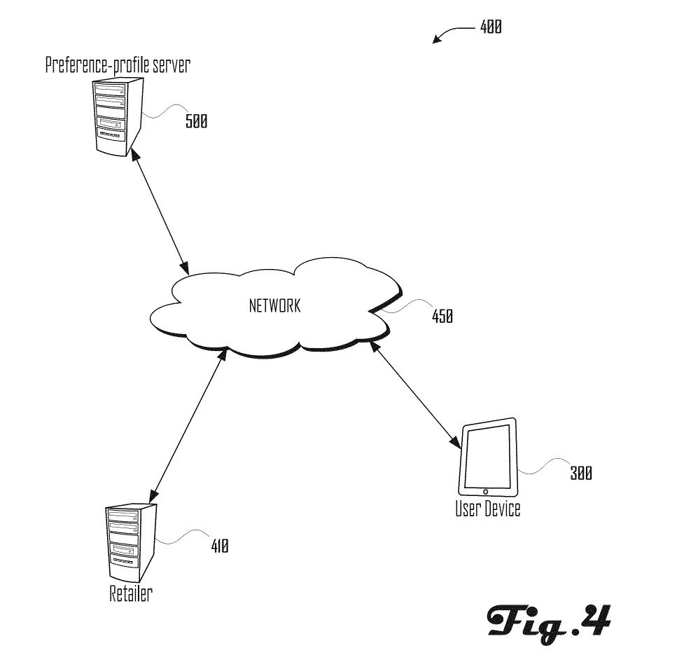

FIG. 3 illustrates a preference-based sensory shopping user interface 300, in accordance with one embodiment. In contrast to prior-art shopping user-interface 100 (see FIG. 100, discussed above), sensory shopping user interface 300 presents a non-overwhelming sample of 5-10 products that are chosen to have characteristics that are a likely match to the consumer's sensory-preference profile.

FIG. 4 illustrates a consumer-preference profile system in accordance with one embodiment. Preference-profile consumer device 600, retailer server 110, and preference-profile server 500 are connected to network 150. In various embodiments, preference-profile server 500 may comprise one or more physical and/or logical devices that collectively provide the functionalities described herein. In some embodiments, preference-profile server 500 may comprise one or more replicated and/or distributed physical or logical devices. In some embodiments, preference-profile server 500 may comprise one or more computing resources provisioned from a “cloud computing” provider.

In various embodiments, network 150 may include the Internet, a local area network (“LAN”), a wide area network (“WAN”), a cellular data network, and/or other data network. In various embodiments, preference-profile consumer device 600 may include desktop PCs, mobile phones, laptops, tablets, or other computing devices that are capable of connecting to network 150 and consuming and/or providing services such as those described herein.

In many embodiments, there may be more than one retailer server 110 represented within the system.

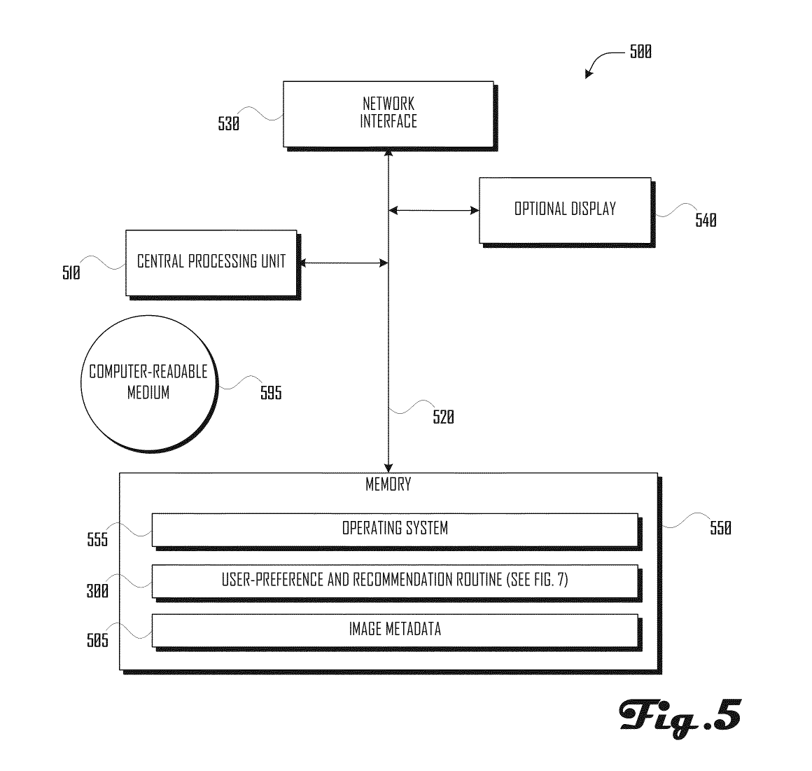

FIG. 5 illustrates several components of an exemplary preference-profile server in accordance with one embodiment. In some embodiments, preference-profile server 500 may include many more components than those shown in FIG. 5. However, it is not necessary that all of these generally conventional components be shown in order to disclose an illustrative embodiment.

Preference-profile server 500 also includes a processing unit 510, a memory 550, and an optional display 540, all interconnected along with the network interface 530 via a bus 520. The memory 550 generally comprises a random access memory (“RAM”), a read only memory (“ROM”), and a permanent mass storage device, such as a disk drive. The memory 550 stores program code for a routine 700 for determining a consumer-preference profile based on consumer selections of metatagged images (see FIG. 7, discussed below). In addition, the memory 550 also stores an operating system 555 and image metadata 505.

These and other software components may be loaded into memory 550 of preference-profile server 500 using a drive mechanism (not shown) associated with a non-transient computer readable storage medium 595, such as a floppy disc, tape, DVD/CD-ROM drive, memory card, or the like. In some embodiments, software components may alternately be loaded via the network interface 530, rather than via a non-transient computer readable storage medium 595.

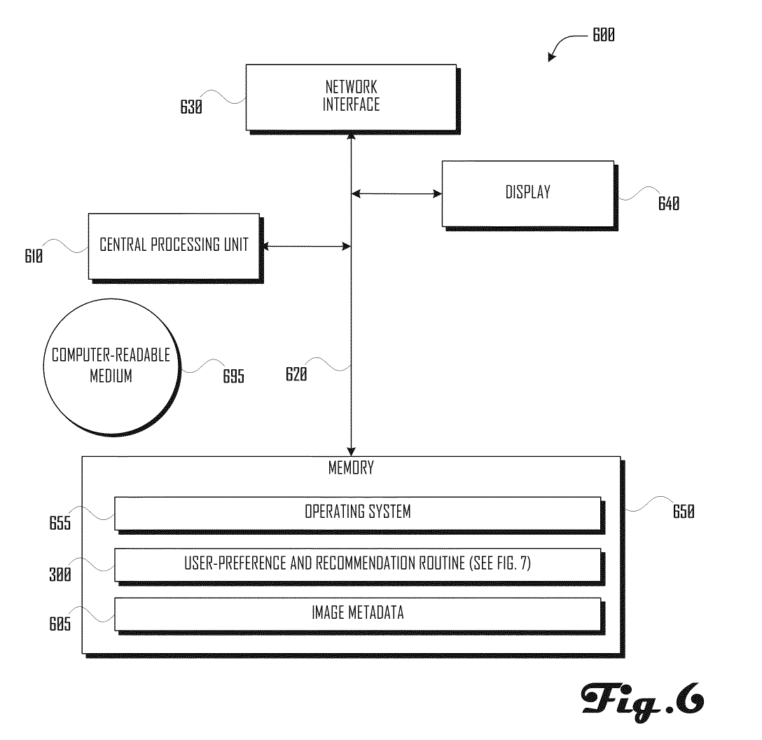

FIG. 6 illustrates several components of an exemplary preference-profile consumer device in accordance with one embodiment. In some embodiments, preference-profile consumer device 600 may include many more components than those shown in FIG. 6. However, it is not necessary that all of these generally conventional components be shown in order to disclose an illustrative embodiment.

Preference-profile consumer device 600 also includes a processing unit 610, a memory 650, and a display 640, all interconnected along with the network interface 630 via a bus 620. The memory 650 generally comprises a random access memory (“RAM”), a read only memory (“ROM”), and a permanent mass storage device, such as a disk drive. The memory 650 stores program code for a routine 700 for determining a consumer-preference profile based on consumer selections of metatagged images (see FIG. 7, discussed below). In addition, the memory 650 also stores an operating system 655 and image metadata 605.

These and other software components may be loaded into memory 650 of preference-profile consumer device 600 using a drive mechanism (not shown) associated with a non-transient computer readable storage medium 695, such as a floppy disc, tape, DVD/CD-ROM drive, memory card, or the like. In some embodiments, software components may alternately be loaded via the network interface 630, rather than via a non-transient computer readable storage medium 695.

FIG. 7 illustrates a routine 700 for determining a consumer-preference profile based on consumer selections of meta-tagged images, such as may be performed by a preference-profile server 500 and/or a preference-profile consumer device 600 in accordance with one embodiment.

In block 705, routine 700 determines a product category that a consumer is interested in. For example, in one embodiment, routine 700 may present a text-entry and/or list-selection control with which a consumer can enter and/or select a product category. In various embodiments, a product category may refer to an article of clothing (e.g., blazers, skirts, or the like). In other embodiments, a product category may refer to a non-clothing product (e.g., automobile, furniture, or the like) for which visual aesthetics play a significant role in selecting a particular item.

In block 710, routine 700 determines a plurality of visual-aesthetic profile categories associated with the product category (as determined in block 705). In various embodiments, an expert in a given product category may have previously defined several broad classifications according to which consumer's taste and style preferences may be categorized as discussed herein. For example, in one embodiment, the following set of visual-aesthetic profile categories may be employed in connection with clothing-related product categories:
simplicity (SI);
classic modern (CM);
urban collector (UC);
urbanista (UA);
post-modern explorer (PM); and
contemporary functionalist (CF).

In block 715, routine 700 selects a multiplicity of meta-tagged images, each having visual aesthetic qualities that are associated with one or more visual aesthetic profile category variants. See, e.g., personal curation user-interface 200 (see FIG. 2, discussed above). For example, in one embodiment, an exemplary set of meta tagged images may each be associated to varying degrees with visual-aesthetic profile categories, such as set forth in Table 1 (below). In other embodiments, more or fewer meta-tagged images may be employed.

TABLE 1
Exemplary meta-tagged images category metadata

| | | Classic | Urban | | Post-Modern | Contemporary |
|---|---|---|---|---|---|---|
| | Simplicity | Modern | Collector | Urbanista | Explorer | Functionalist |
| Image | (SI) | (CM) | (UC) | (UA) | (PM) | (CF) |
| 1 | 80 | 0 | 10 | 10 | 0 | 0 |
| 2 | 10 | 20 | 50 | 10 | 10 | 0 |
| 3 | 0 | 0 | 10 | 50 | 20 | 20 |
| 4 | 0 | 0 | 10 | 20 | 50 | 20 |
| 5 | 0 | 0 | 5 | 15 | 25 | 55 |
| 6 | 0 | 80 | 0 | 0 | 0 | 20 |
| 7 | 10 | 10 | 60 | 10 | 10 | 0 |
| 8 | 0 | 0 | 5 | 15 | 20 | 60 |
| 9 | 0 | 0 | 5 | 10 | 60 | 25 |
| 10 | 20 | 40 | 10 | 20 | 10 | 0 |
| 11 | 0 | 0 | 5 | 5 | 20 | 70 |
| 12 | 60 | 20 | 10 | 10 | 0 | 0 |
| 13 | 5 | 15 | 70 | 5 | 5 | 0 |
| 14 | 0 | 0 | 5 | 10 | 70 | 15 |
| 15 | 0 | 60 | 10 | 10 | 10 | 10 |
| 16 | 10 | 0 | 0 | 60 | 20 | 10 |
| 17 | 50 | 40 | 0 | 10 | 0 | 0 |
| 18 | 65 | 20 | 10 | 5 | 0 | 0 |
| 19 | 0 | 0 | 20 | 40 | 20 | 20 |
| 20 | 0 | 10 | 75 | 10 | 5 | 0 |
| 21 | 0 | 0 | 15 | 20 | 25 | 40 |
| 22 | 10 | 65 | 15 | 10 | 0 | 0 |
| 23 | 0 | 0 | 10 | 70 | 15 | 5 |
| 24 | 80 | 15 | 5 | 0 | 0 | 0 |
| 25 | 0 | 0 | 0 | 10 | 10 | 80 |

As shown in Table 1, each meta-tagged image is associated with a plurality of determinant components. For example, meta-tagged image number 1 has three nonzero determinant components: a ‘Simplicity’ determinant component with a value or weight of 80, an ‘Urban Collector’ component with a value or weight of 10, and an ‘Urbanists’ determinant component with a value or weight of 10. Similarly, metatagged image number 2 has five non-zero determinant components: ‘Simplicity’, ‘Classic Modern’, ‘Urban Collector’, ‘Urbanists’, and ‘Post-Modern Explorer’ with values or weights of 10, 20, 50, 10, and 10, respectively.

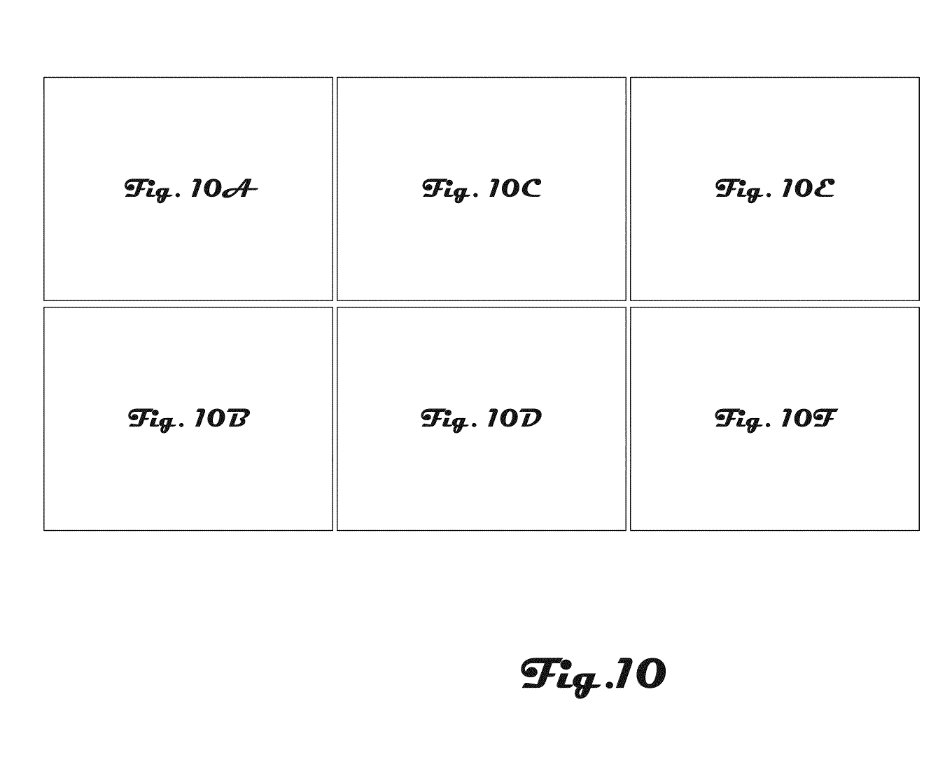

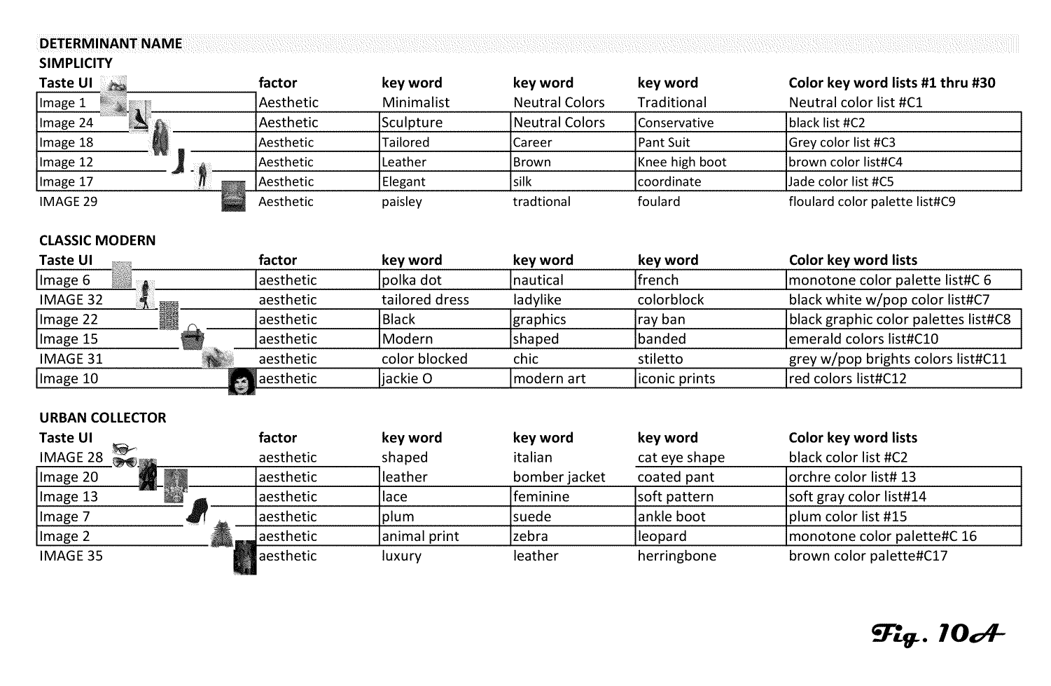

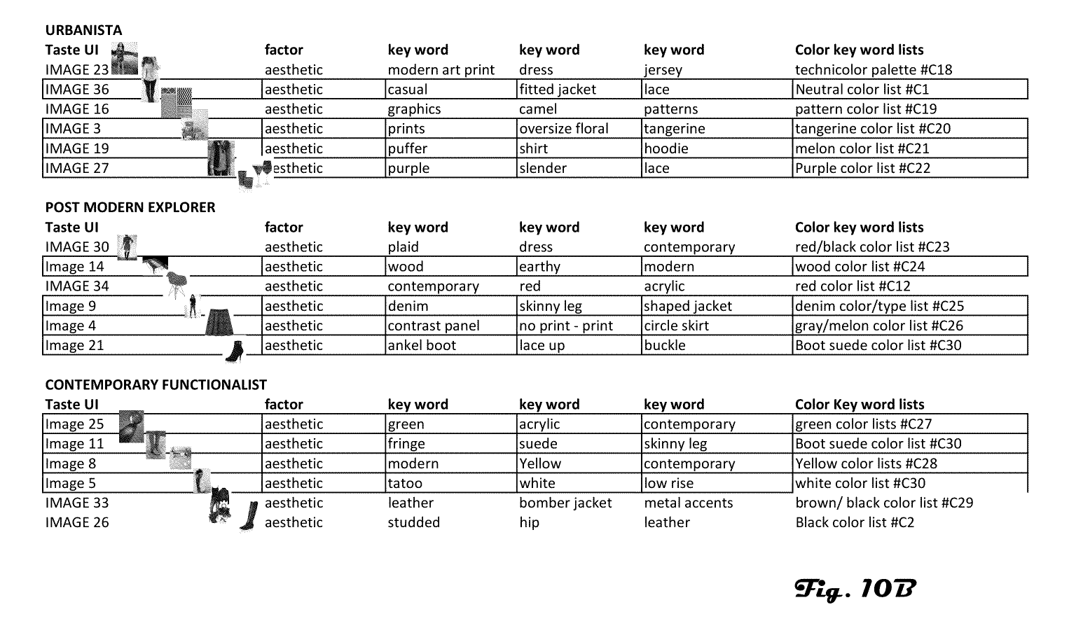

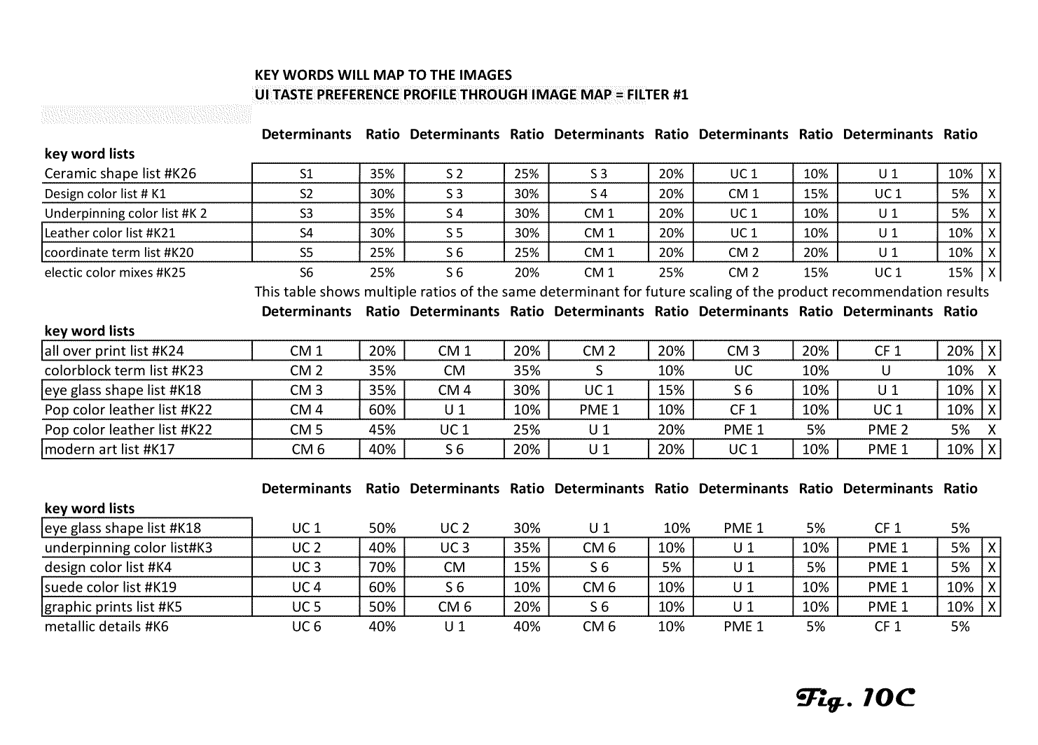

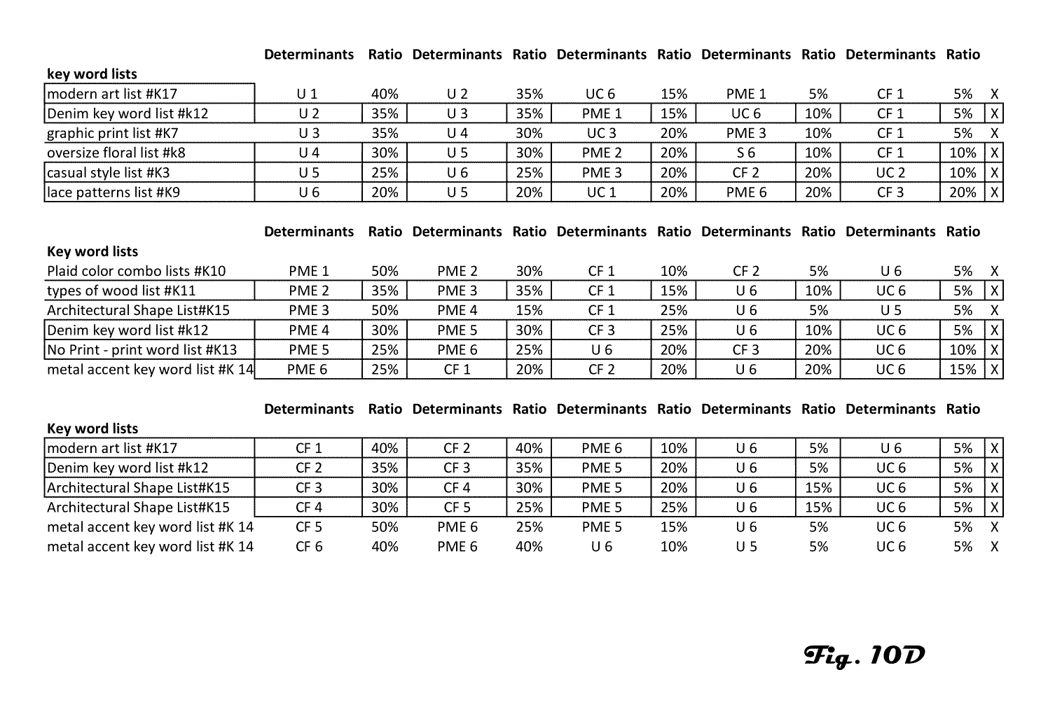

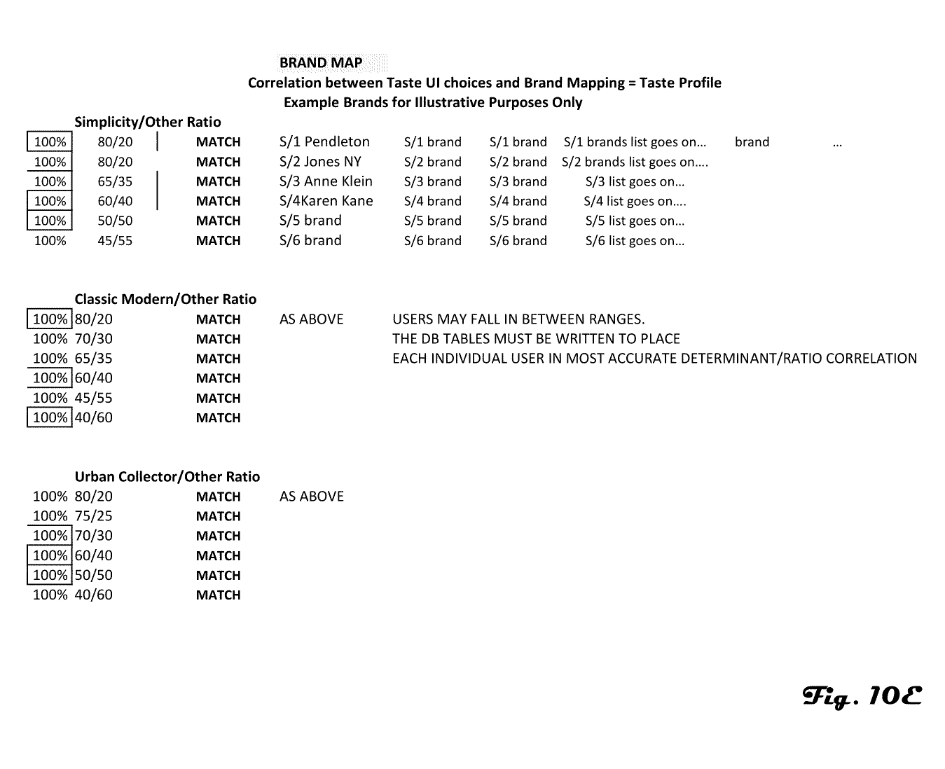

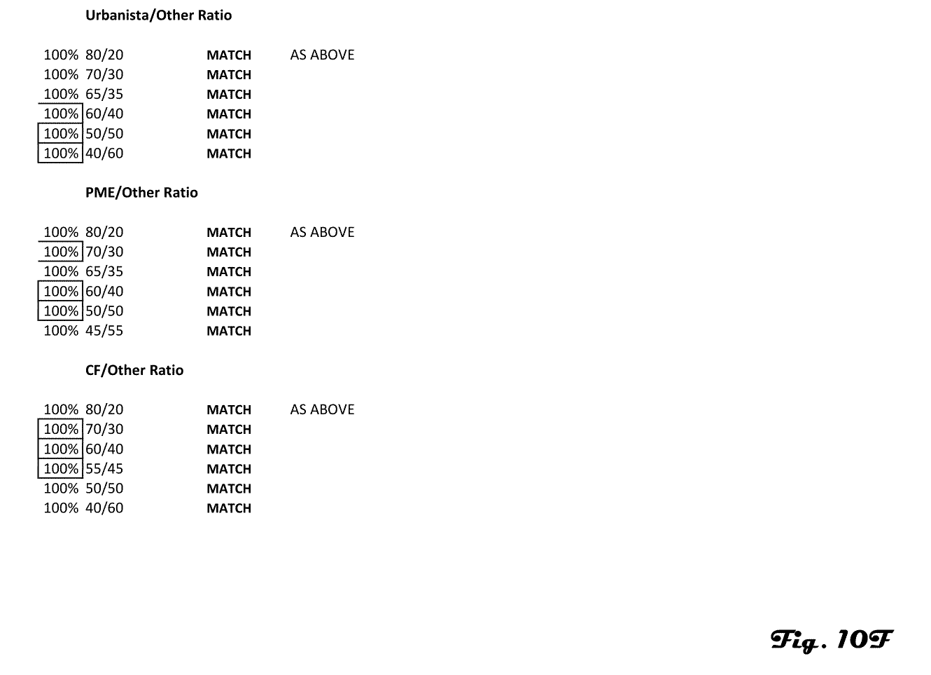

In some embodiments, each meta-tagged image may also be associated with one or more keywords, such as shown in FIGS. 10A-F. In other embodiments, each visual-aesthetic profile category may include several variants or sub-categories, denoted herein with numeric postfixes (e.g. SI-1, SI-2, SI-3; CM-1, CM-2, CM-3; and the like).

In such embodiments, an exemplary set of meta-tagged images may each be associated to varying degrees with several visual-aesthetic profile category variants, such as set forth in Table 2. For each meta-tagged image and visual-aesthetic profile category variant, the table cell includes a variant identifier (e.g., ‘SI-1’) and a parenthesized a weight value (e.g., 35).

TABLE 2
Exemplary meta-tagged images category/variant metadata

| | Primary | Secondary | Tertiary | Quaternary | Quinary |
|---|---|---|---|---|---|
| Image | Variant | Variant | Variant | Variant | Variant |
| 1 | SI-1 (35) | SI-2 (25) | SI-3 (20) | UC-1 (10) | UA-1 (10) |
| 2 | UC-5 (50) | CM-6 (20) | SI-6 (10) | UA-1 (10) | PM-1 (10) |
| 3 | UA-5 (25) | UA-6 (25) | PM-3 (20) | CF-2 (20) | UC-2 (10) |
| 4 | PM-5 (25) | PM-6 (25) | UA-6 (20) | CF-3 (20) | UC-6 (10) |
| 5 | CF-4 (30) | CF-5 (25) | PM-5 (25) | UA-6 (15) | UC-6 (5) |
| 6 | CM-1 (20) | CM-1 (20) | CM-2 (20) | CM-3 (20) | CF-1 (20) |
| 7 | UC-4 (60) | SI-6 (10) | CM-6 (10) | UA-1 (10) | PM-1 (10) |
| 8 | CF-3 (30) | CF-4 (30) | PM-5 (20) | UA-6 (15) | UC-6 (5) |
| 9 | PM-4 (30) | PM-5 (30) | CF-3 (25) | UA-6 (10) | UC-6 (5) |
| 10 | CM-6 (40) | SI-6 (20) | UA-1 (20) | UC-1 (10) | PM-1 (10) |
| 11 | CF-2 (35) | CF-3 (35) | PM-5 (20) | UA-6 (5) | UC-6 (5) |
| 12 | SI-4 (30) | SI-5 (30) | CM-1 (20) | UC-1 (10) | UA-1 (10) |
| 13 | UC-3 (70) | CM-1 (15) | SI-6 (5) | UA-1 (5) | PM-1 (5) |
| 14 | PM-2 (35) | PM-3 (35) | CF-1 (15) | UA-6 (10) | UC-6 (5) |
| 15 | CM-4 (60) | UA-1 (10) | PM-1 (10) | CF-1 (10) | UC-1 (10) |
| 16 | UA-4 (30) | UA-5 (30) | PM-2 (20) | SI-6 (10) | CF-1 (10) |
| 17 | SI-5 (25) | SI-6 (25) | CM-1 (20) | CM-2 (20) | UA-1 (10) |
| 18 | SI-3 (35) | SI-4 (30) | CM-1 (20) | UC-1 (10) | UA-1 (5) |
| 19 | UA-6 (20) | UA-5 (20) | UC-1 (20) | PM-6 (20) | CF-3 (20) |
| 20 | UC-2 (40) | UC-3 (35) | CM-6 (10) | UA-1 (10) | PM-1 (5) |
| 21 | PM-6 (25) | CF-1 (20) | CF-2 (20) | UA-6 (20) | UC-6 (15) |
| 22 | CM-3 (35) | CM-4 (30) | UC-1 (15) | SI-6 (10) | UA-1 (10) |
| 23 | UA-2 (35) | UA-3 (35) | PM-1 (15) | UC-6 (10) | CF-1 (5) |
| 24 | SI-2 (30) | SI-3 (30) | SI-4 (20) | CM-1 (15) | UC-1 (5) |
| 25 | CF-1 (40) | CF-2 (40) | PM-6 (10) | UA-6 (5) | UA-6 (5) |

As shown in Table 2, each meta-tagged image is associated with five determinant components. For example, meta-tagged image number 1 has a primary determinant components with a visual-aesthetic profile category variant of ‘SI-1’ and a weight or value of 35, a secondary determinant components with a visual-aesthetic profile category variant of ‘SI-2’ and a weight or value of 25, a tertiary determinant components with a visual-aesthetic profile category variant of ‘SI-3’ and a weight or value of 20, a quaternary determinant components with a visual-aesthetic profile category variant of ‘UC-1’ and a weight or value of 10, and a quinary determinant components with a visual-aesthetic profile category variant of ‘UA-1’ and a weight or value of 10.

In various embodiments, some (or all) of the selected meta-tagged images may depict products of the product category (as determined in block 705), but in other embodiments, the meta-tagged images need not depict such products.

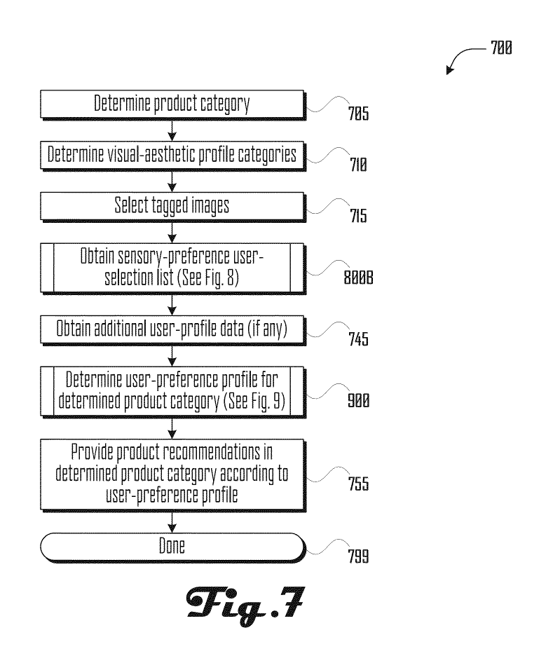

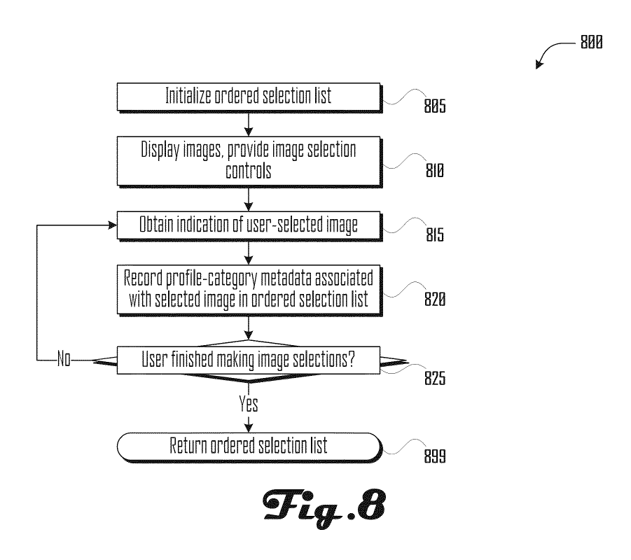

In subroutine block 800, routine 700 calls subroutine 800 (see FIG. 8, discussed below) to present the meta-tagged images selected in block 715 to the consumer and to collect an ordered taste-image selection list indicating a plurality of meta-tagged images that were selected by the consumer and an order in which they were selected.

In block 745, routine 700 obtains additional non-aesthetic consumer-profile-related data (if any) that may be relevant to the consumer's decision to purchase a product of the product category (as determined in block 705). For example, in one embodiment, routine 700 may obtain data indicating a size or range of sizes in which the consumer has previously purchased or is interested in prospectively purchasing such a product. Similarly, in one embodiment, routine 700 may obtain data indicating a price or price range in which the consumer has previously purchased or is interested in prospectively purchasing such a product. In various embodiments, such data may be obtained by presenting a user-interface via which the consumer may select and/or enter the requested data.

In subroutine block 900, routine 700 determines a consumer-preference profile for the product category (as determined in block 705) based on the consumer selection lists obtained in subroutine 800 and on additional non-aesthetic consumer profile-related data (if any) obtained in block 745.

In block 755, routine 700 provides one or more product recommendations in the product category (as determined in block 705) based on the consumer preference profile (as determined in subroutine block 900).

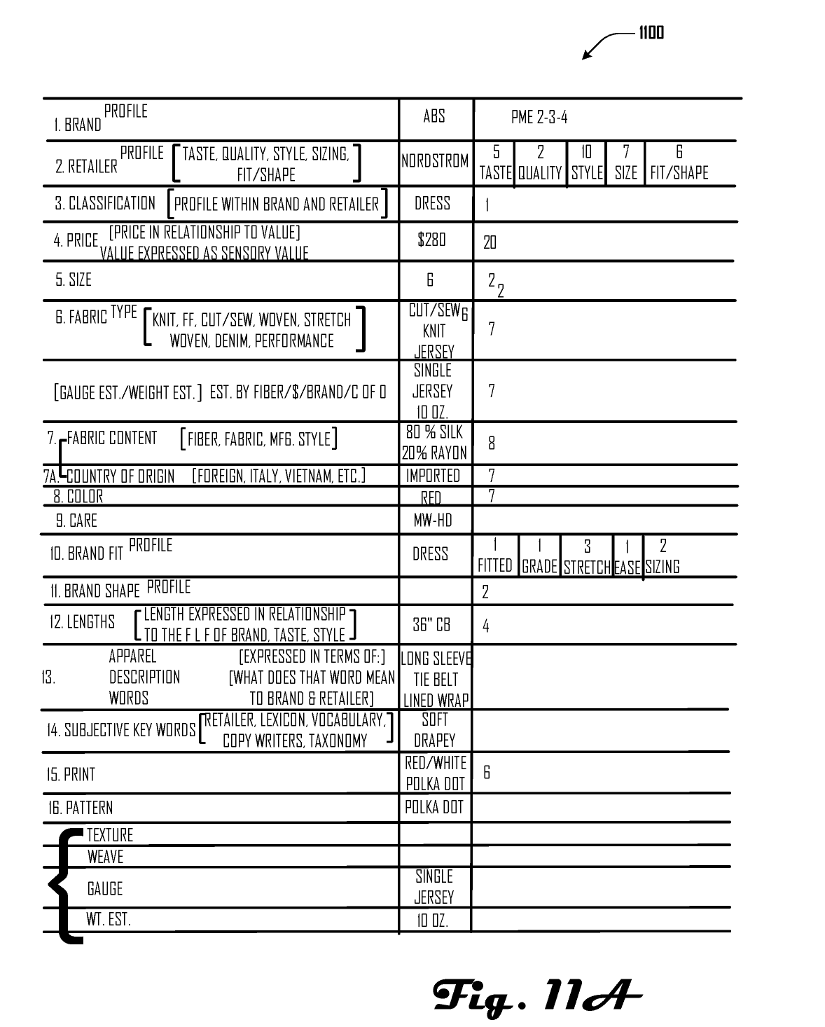

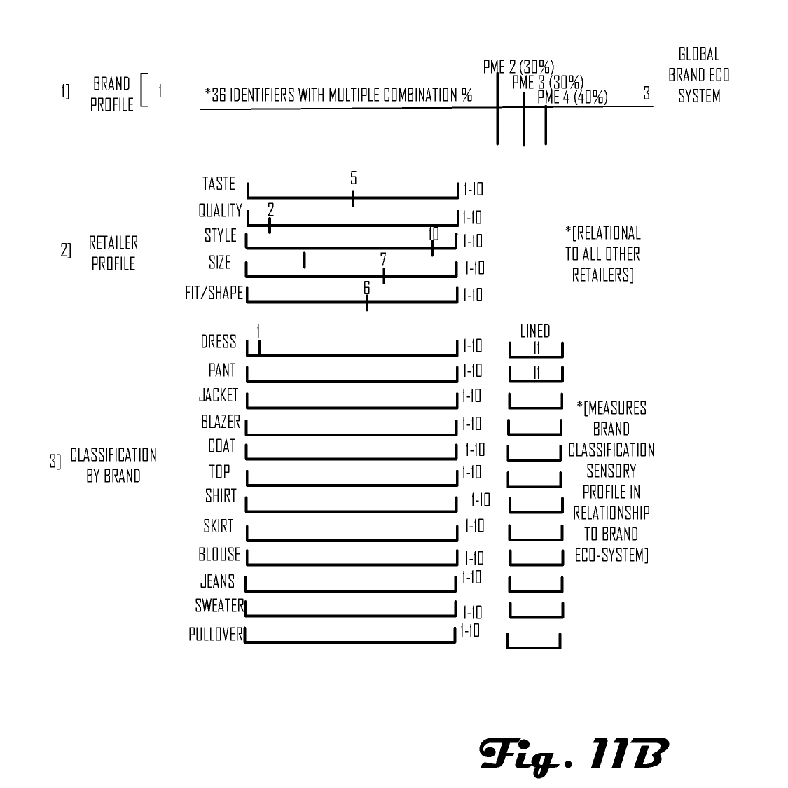

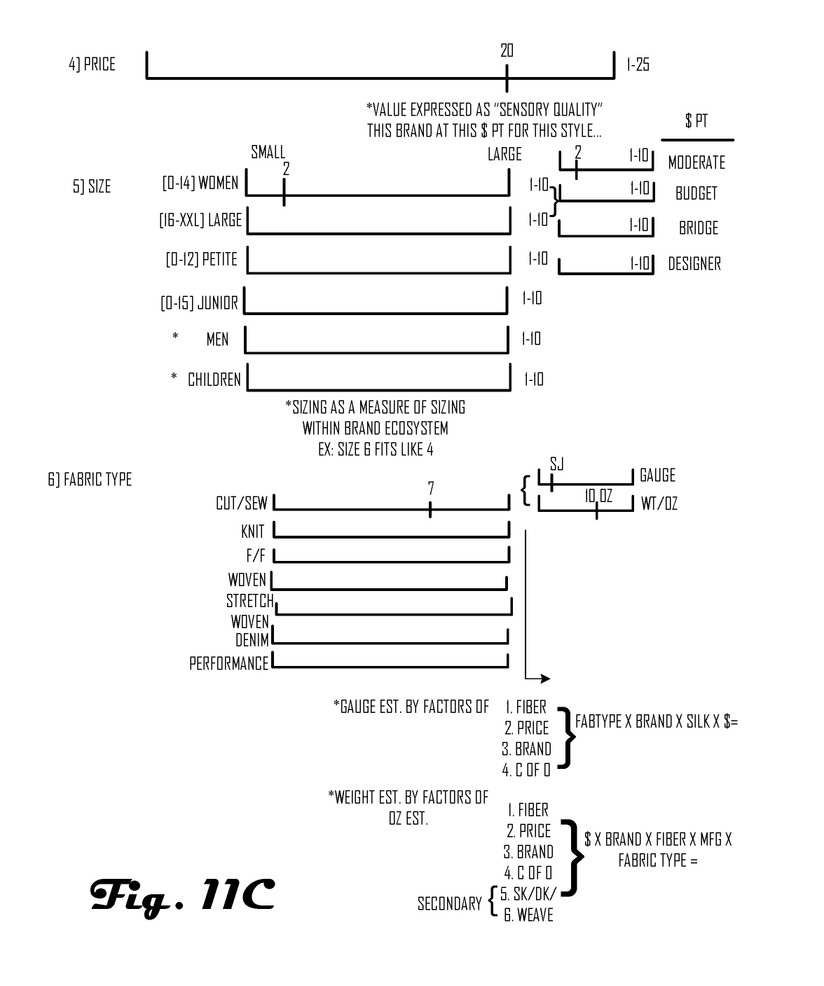

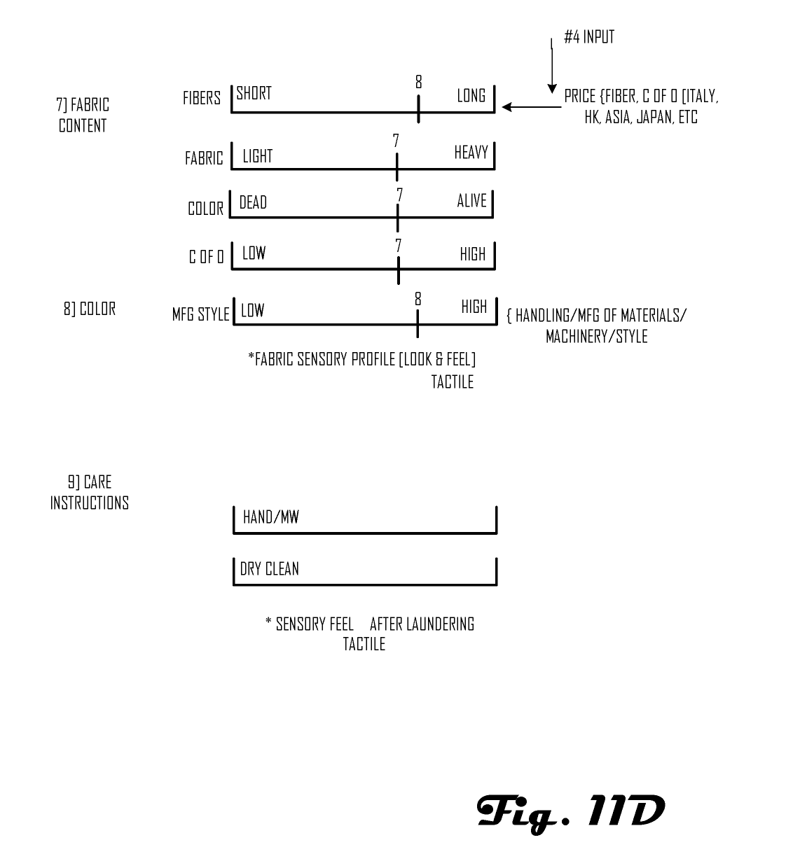

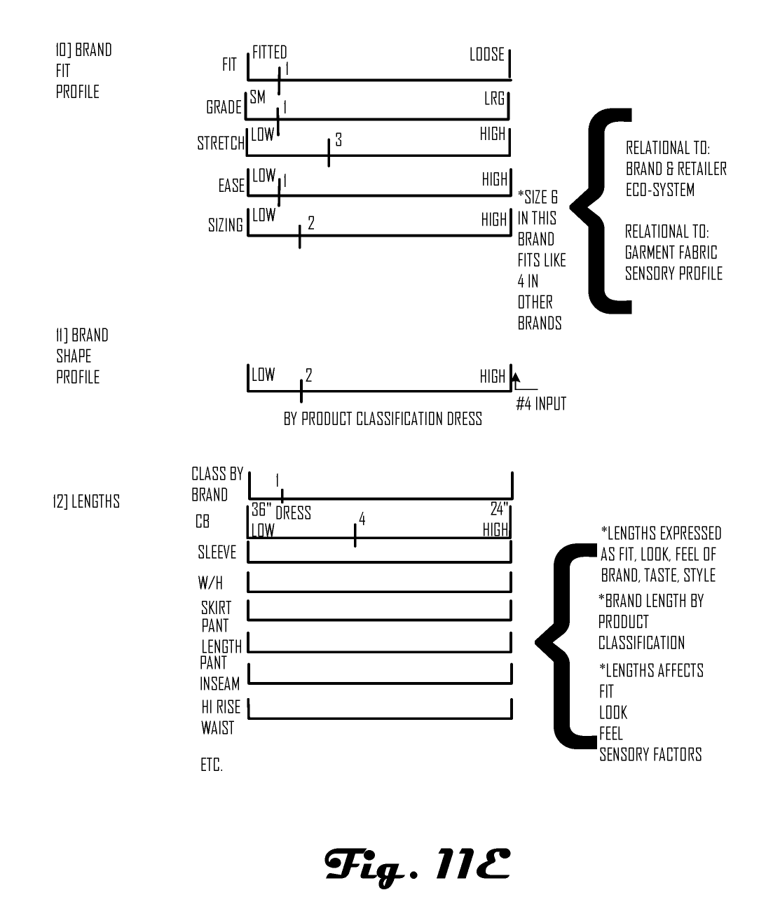

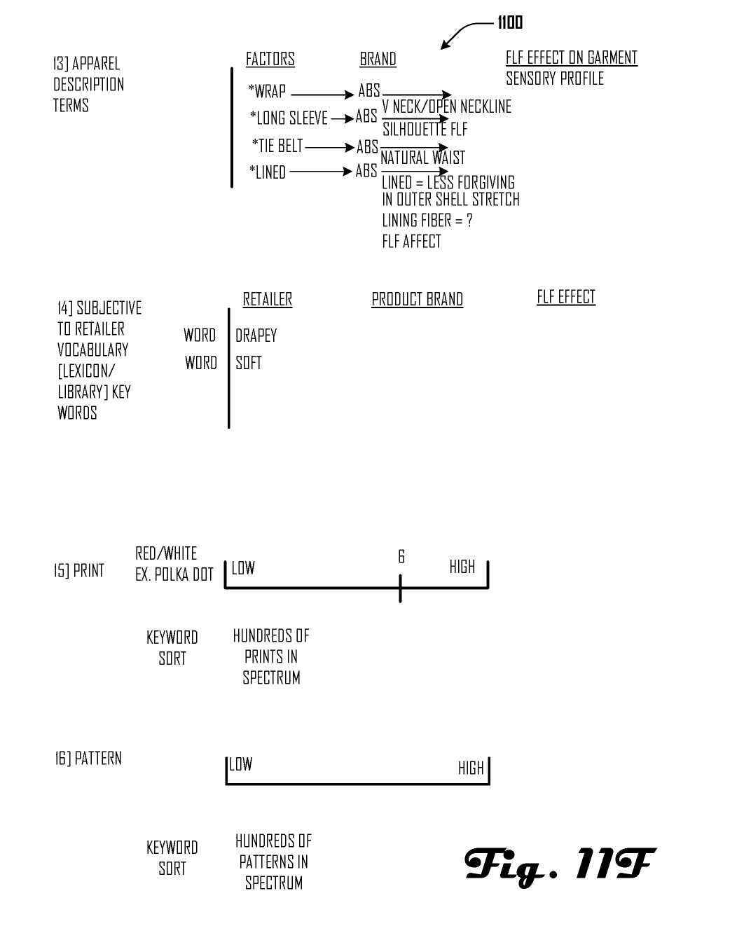

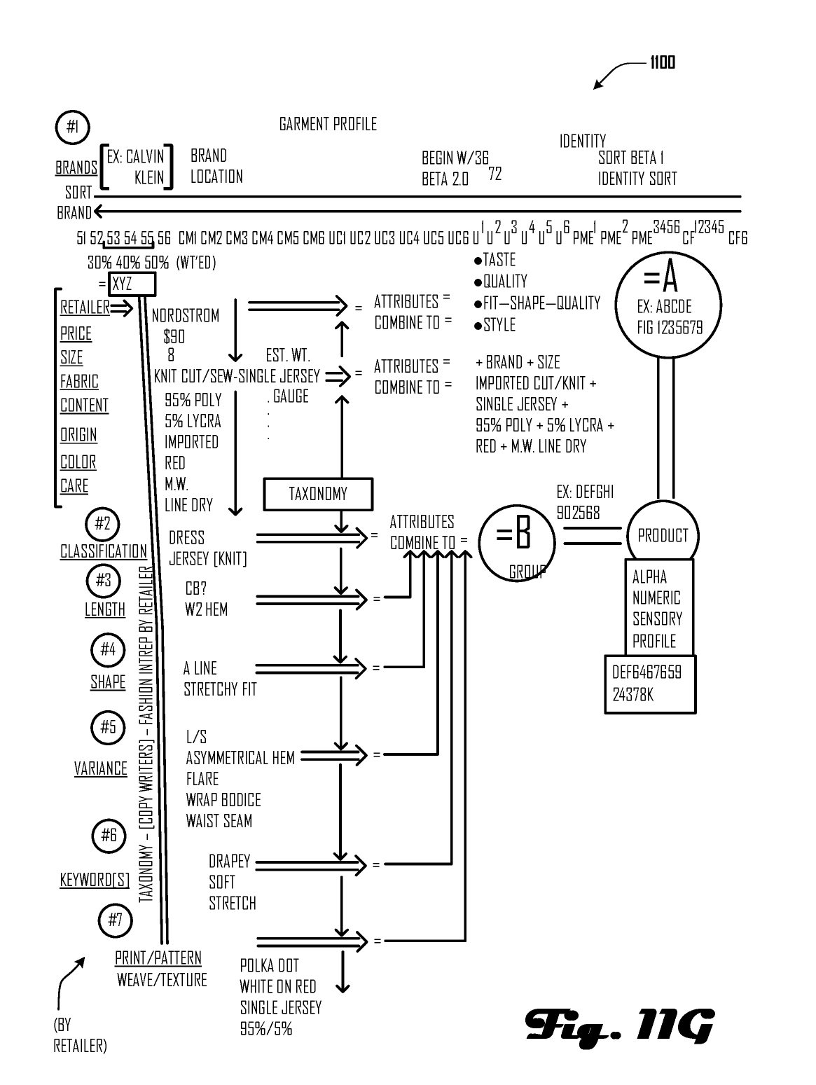

In various embodiments, as shown in FIGS. 11A-G (below) products in a given product category may be profiled according to various product-category-specific aesthetic attributes to obtain product preference profiles of products. For example, in one embodiment, products in product categories related to garments may be profiled according to attributes such as some or all of the following to obtain a garment preference profile:

Retailer

Brand

Classification

Silhouette

Price

Knit

Woven

Stretch Woven

Center Back Length from waist

Length from Shoulder

Center Back Length from Neck

Rise

Inseam

Size

Color

Country of Origin

Fabric Content

Fabric Care Instructions

Solid

Pattern Description

Additionally, in some embodiments, products in product categories related to garments may be profiled according to fit attributes such as some or all of the

following:

loose

easy

slim

stretchy

relaxed

Additionally, in some embodiments, products in product categories related to garments may be profiled according to shape attributes such as some or all of the

following:

skimming

shaped

block

boxy

shaped

princess

A-Line

In some embodiments, products in product categories related to garments may also or instead be profiled according to design attributes such as some or all of the following:

asymmetrical

long sleeves

short sleeves—length

cap sleeves

straight

flare

bell

boot cut

skinny

More specific products in product categories related to garments (e.g., Jeans, Pants, Skirts, and the like) may be profiled according to classification attributes such as some or all of the following:

Jeans—woven—inseam—rise

Jeans—stretch woven-inseam—rise

Jeans—knit—inseam—rise

Pants—woven—inseam—rise

Pants—stretch woven—inseam—rise

Pants—knit—inseam—rise

Tops—knit—length

Tops—stretch woven—length

Tops—woven—length

Blouses—woven—length

Blouses—stretch woven—length

Blouses—knit—length

Sweaters—full fashion—length

Sweaters—cut and sew—length

Cardigans—Cut and sew—length

Cardigans—full fashion—length

Jackets—woven—length

Jackets—stretch woven—length

Jackets—knit—length

Jackets—leather—length

jackets—suede—length

jackets—stretch woven—length

Blazer—woven—length

Blazer—stretch woven—length

Blazer—knit—length

Dresses—woven—length

Dresses—stretch woven—length

Dresses—jersey—length

Dresses—knit—length

Coats—knit—length

Coats—woven—length

Coats—stretch woven—length

Coats—leather—length

Coats—suede—length

T-Shirts—knit—length

Skirts—woven—Length

Skirts—knit—length

skirts—stretch woven—length

Using product preference profiles incorporating attributes such as those listed above, routine 700 may match the consumer-preference profile (as determined in subroutine block 900) with one or more recommended products and present such products to the consumer.

For example, in one embodiment, different brands may be associated with different product categories and/or with different visual-aesthetic profile category variants. In other words, Brand X may be associated with visual-aesthetic profile category variant ‘SI-1’, while Brand Y may be associated with visual-aesthetic profile category variant ‘SI-2’, and so on. Similarly, other product attributes may be similarly associated with various product categories and/or visual-aesthetic profile category variants.

Routine 700 ends in ending block 799.

FIG. 8 illustrates a subroutine 800 for obtaining an ordered consumer selection list based on a given set of meta-tagged images, such as may be performed by a preference-profile server 500 in accordance with one embodiment.

In block 805, subroutine 800 initializes a list, array, hash, object, or other suitable data structure for storing an ordered collection of selected meta-tagged images (hereinafter “ordered consumer-selection list”).

In block 810, subroutine 800 displays the given set of meta-tagged images, providing image-selection controls to enable to consumer to select one or more of the meta-tagged images, such as by touching or otherwise selecting one or more metatagged images. See, e.g., personal curation user-interface 200 (see FIG. 2, discussed above).

In block 815, subroutine 800 obtains an indication of an indicated metatagged image that the consumer has selected via the image-selection controls (as provided in block 810).

In block 820, subroutine 800 adds the selected meta-tagged image to the ordered consumer-selection list (as initialized in block 805), such that the metadata associated with the selected meta-tagged image may be accessed by the calling routine.

In decision block 825, subroutine 800 determines whether the consumer has indicated that he or she is finished selecting meta-tagged images. In some embodiments, the consumer may be encouraged to make 3-4 selections to improve the quality of the consumer-preference profile that may be determined (as discussed below).

If subroutine 800 does not determine that the consumer has indicated that he or she is finished selecting meta-tagged images, then subroutine 800 loops back to ‘block 815’ to process the next selected meta-tagged image. Otherwise, subroutine 800 proceeds to ending block 899.

Subroutine 800 ends in ending block 899, returning to the caller the ordered consumer-selection list as updated in one or more iterations of block 820.

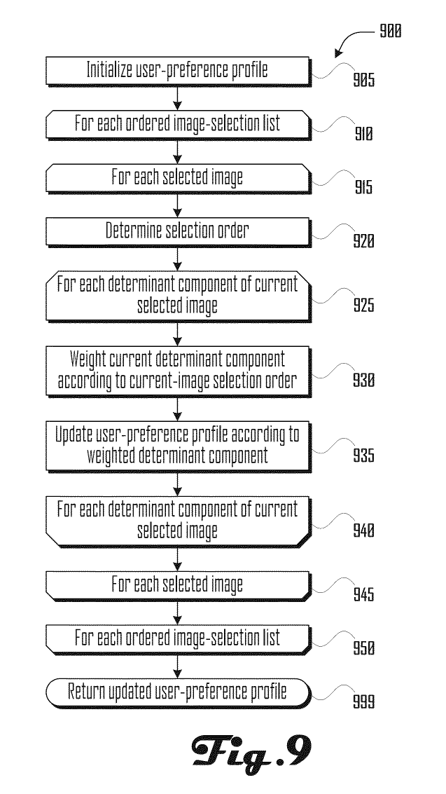

FIG. 9 illustrates a subroutine 900 for determining a consumer preference profile based on one or more given ordered consumer-selection lists, such as may be performed by a preference-profile server 500 in accordance with one embodiment.

In block 905, subroutine 900 initializes a list, array, string, object, hash, or other suitable data structure for storing a consumer-preference profile, as discussed below (hereinafter consumer-preference-profile data structure).

In block 920, subroutine 900 determines an order in which the consumer selected the current selected meta-tagged image (e.g., whether the consumer selected the current selected meta-tagged image of the current ordered consumer-selection list first, second, third, and so on).

As discussed above, a meta-tagged image is associated with metadata including one or more determinant components indicating a degree to which the metatagged 's image visual aesthetic qualities are aligned with one or more visual-aesthetic profile category variants.

In block 930, subroutine 900 weights or adjusts the current determinant component of the current selected meta-tagged image of the current ordered consumer-selection list according to the order in which the consumer selected the current selected meta-tagged image to obtain an order-adjusted determinant component.

For example, in one embodiment, determinant component values may be adjusted based on selection order using a set of adjustment factors similar to the following set: [1, 0.95, 0.89, 0.84, 0.77, 0.71, 0.63, 0.55, 0.45, 0.32]. In such embodiments, a determinant component value (e.g., 35) of a meta-tagged image that was selected first may be adjusted according to an adjustment factor of 1 (e.g., for an adjusted value of 35); while a determinant component value (e.g., 35) of a metatagged image that was selected second may be adjusted according to an adjustment factor of 0.95 (e.g., for an adjusted value of 33.25); and so on.

In block 935, subroutine 900 updates consumer-preference profile (as initialized in block 905) according to the order-adjusted determinant component (as determined in block 930). In some embodiments, each ordered consumer-selection list may be associated with a discrete component of the consumer-preference profile being determined in subroutine 900. For example, in one embodiment, an ordered consumer-selection list composed of meta-tagged taste images may be associated with a “taste” portion of the consumer-preference profile, while an ordered consumer selection list composed of meta-tagged style images may be associated with a “style” portion of the consumer-preference profile.

For example, using the exemplary adjustment factors listed above and the determinant components enumerated in Table 1 (above), if a consumer selected meta tagged taste images 1, 2, and 3 (in that order), then in one embodiment, subroutine 900 may ultimately determine a “taste” portion of a consumer-preference profile similar to the following: {SI:31; CM:7; UC:23; UA:23; PM:10; CF:6}.

Similarly, if a consumer selected images 1, 2, and 3 (in that order), each having visual-aesthetic profile category metadata as shown in Table 2 (above), then in one embodiment, subroutine 900 may determine a “taste” portion of a consumer preference profile similar to the following: {(SI-1):12; (SI-2):9; (SI-3):7; (UC-1):4; (UA-1):7; (UC-5):17; (CM-6):7; (SI-6):3; (PM-1):3; (UA-5):8; (UA-6):8; (PM-3):6; (CF-2):6; (UC-2):3}.

In other embodiments, subroutine 900 may employ different and/or additional signals when determining a consumer-preference profile. For example, in some embodiments, subroutine 900 may also consider which meta-tagged images the consumer failed to select.

Once all ordered consumer-selection lists have been processed, subroutine 900 ends in ending block 999, returning to the caller the consumer preference profile as determined in one or more iterations of block 935.

FIGS. 10A-F illustrate an alternate set of exemplary metadata that may be employed in connection with a set of meta-tagged images, in accordance with one embodiment.

FIG. 11A illustrates exemplary metadata 1100 that may be employed in connection with a set of meta-tagged images, in accordance with one embodiment. FIG. 11B also illustrates exemplary metadata that may be employed in connection with a set of meta-tagged images. FIG. 11C also illustrates exemplary metadata that may be employed in connection with a set of meta-tagged images. FIG. 11D also illustrates exemplary metadata that may be employed in connection with a set of meta-tagged images. FIG. 11E also illustrates exemplary metadata that may be employed in connection with a set of meta-tagged images. FIG. 11F also illustrates exemplary metadata that may be employed in connection with a set of meta-tagged images. FIG. 11G also illustrates exemplary metadata that may be employed in connection with a set of meta-tagged images.

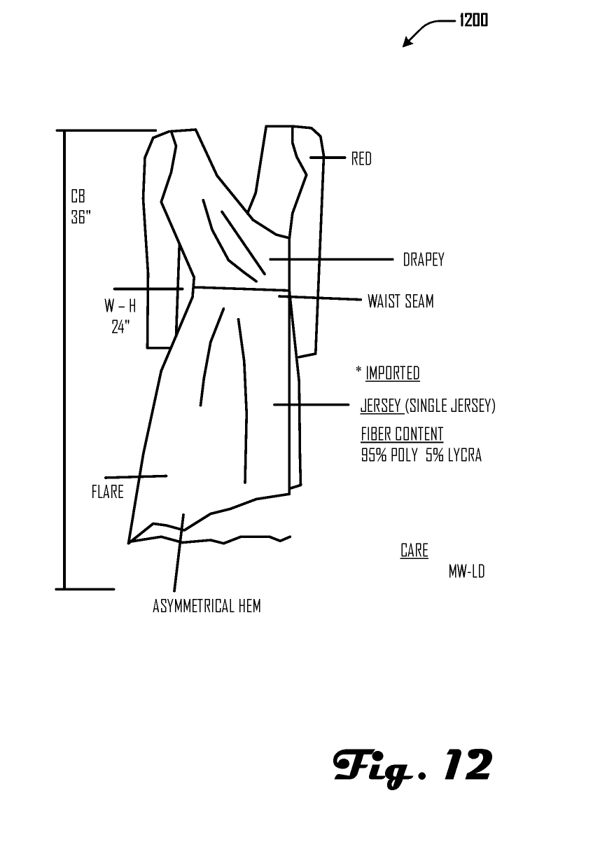

FIG. 12 illustrates an exemplary garment having characteristics similar to those described in FIGS. 11A-G, in accordance with one embodiment.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. Systems and methods for sensory-preference-profile-based shopping, as shown and described.
